(19) United States
(12) Patent Application Publication
(10) Pub. No.: US 2006/0158965 A1
(43) Pub. Date: Jul. 20, 2006

(54) Gear train module and electronic device utilizing the same

(75) Inventor: Ho Kang Liu, Taichung City (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/335,095

(22) Filed: Jan. 18, 2006

(30) Foreign Application Priority Data
Jan. 20, 2005 (TW) TW94101651

(51) Int. Cl. G04B 19/02

(52) U.S. Cl. 368/220

(57) ABSTRACT

A gear train module and an electronic device utilizing the same. A solenoid valve includes a body and a sliding rod protruding from the body. When the solenoid valve is not actuated, the sliding rod is in a first position. When the solenoid valve is actuated, the sliding rod is in a second position. A sliding platform is connected to the sliding rod to be moved between the first position and the second position. A first gear unit is disposed on the sliding platform to be engaged with an input gear and an output gear of a driving device when the sliding platform is in the first position. A second gear unit is disposed on the sliding platform to be engaged with the input gear and the output gear when the sliding platform is in the second position.

### BACKGROUND

The invention relates to an electronic device and a gear train module thereof, and in particular, to a gear train module with two gear units switched by a solenoid valve.

FIGS. 1a and 1b depict a conventional scanner comprising a gear train module with a single speed reduction ratio. The scanner 10 comprises a stepping motor 1, a base 2, a gear train module 3, a belt 4, a scanning module 5, and a housing 6. The stepping motor 1 actuates the scanning module 5, and is disposed on an upper surface of the base 2 to be connected to an input gear 3a of the gear train module 3 located at a lower surface of the base 2. The belt 4 is connected to the scanning module 5 and an output gear 3b of the gear train module 3 respectively. The stepping motor 1, the base 2, the gear train module 3, the belt 4, and the scanning module 5 are disposed in the housing 6. The stepping motor 1 drives the scanning module 5 via the gear train module 3 and the belt 4.

The gear train module 3 is provided with a single speed reduction ratio. If the speed reduction ratio is greater, the scanning time increases when low dpi scans or preview scanning.

In view of this, scanners with changeable scanning speed are provided, such as scanners disclosed in Taiwan Patent Pub. No. 421401 and U.S. Pat. No. 6,244,124. The inventor of this application provides another gear train module with changeable speed reduction ratios.

### SUMMARY

Electronic devices are provided. An exemplary embodiment of an electronic device comprises a housing, a passive module, a gear train module, and a driving device. The passive module is moveably disposed in the housing. The gear train module is disposed in the housing to be connected to the passive module. The driving device comprises an input gear and an output gear. Both the input gear and the output gear are engaged with the gear train module respectively to drive the passive module to move. The gear train module comprises a solenoid valve, a sliding platform, a first gear unit, and a second gear unit. The solenoid valve is fixed to the housing, and comprises a body and a sliding rod protruding from the body. When the solenoid valve is not actuated, the sliding rod is in a first position. When the solenoid valve is actuated, the sliding rod is in a second position. The sliding platform is combined with the sliding rod to be moved between the first position and the second position. The first gear unit is disposed on the sliding platform to be engaged with the input gear and the output gear when the sliding platform is in the first position. The second gear unit is disposed on the sliding platform to be engaged with the input gear and the output gear when the sliding platform is in the second position.

Furthermore, the sliding rod comprises a first engaging portion, and the sliding platform comprises a second engaging portion combined with the first engaging portion to combine the sliding rod and the sliding platform. The sliding platform comprises at least one through hole and a plurality of axles combined with the first gear unit and the second gear unit respectively. The gear train module comprises a sliding base, wherein one end of the sliding base is fixed to the housing, and the other end of the sliding base passes through the through hole so that the sliding platform is moved in a predetermined direction.

Moreover, the gear train module further comprises an elastic member. One end of the elastic member abuts the sliding platform to provide elastic force to the sliding platform so that the sliding platform is at the first position when the solenoid valve is not actuated. The sliding platform further comprises a guiding rod on which the elastic member is disposed.

Additionally, the gear train module further comprises a supporting base fixed to the housing, and the body of the solenoid valve is combined with the supporting base to be fixed to the housing. The gear train module further comprises a base plate combined with the supporting base. The base plate comprises an opening. The sliding platform comprises a pin passing through the opening so that the sliding platform is at the second position when the solenoid valve is actuated. The driving device is disposed on the base plate.

Note that the speed reduction ratio of the first gear unit is different than the speed reduction ratio of the second gear unit. The electronic device may be a scanner, and the passive module may be a scanning module.

### DESCRIPTION OF THE DRAWINGS

The invention can be more fully understood by reading the subsequent detailed description and examples with references made to the accompanying drawings, wherein:

FIG. 1a is a schematic view of a conventional scanner;

FIG. 1b is a schematic view of a conventional gear train module;

FIG. 2 is a schematic view of an embodiment of an electronic device;

FIG. 3 is an exploded view of an embodiment of a gear train module;

FIG. 4a is a top view of the gear train module in FIG. 3;

FIG. 4b is a front view of the gear train module in FIG. 3;

FIG. 4c is a side view of the gear train module in FIG. 3;

FIG. 5a is another top view of the gear train module in FIG. 3, wherein a sliding platform is located in a first position, with part of members omitted;

FIG. 5b is another front view of the gear train module in FIG. 3, wherein the sliding platform is located in the first position, with part of members omitted;

FIG. 5c is another top view of the gear train module in FIG. 3, wherein the sliding platform is located in a second position, with part of members omitted; and

FIG. 5d is another front view of the gear train module in FIG. 3, wherein the sliding platform is located in the second position, with part of members omitted.

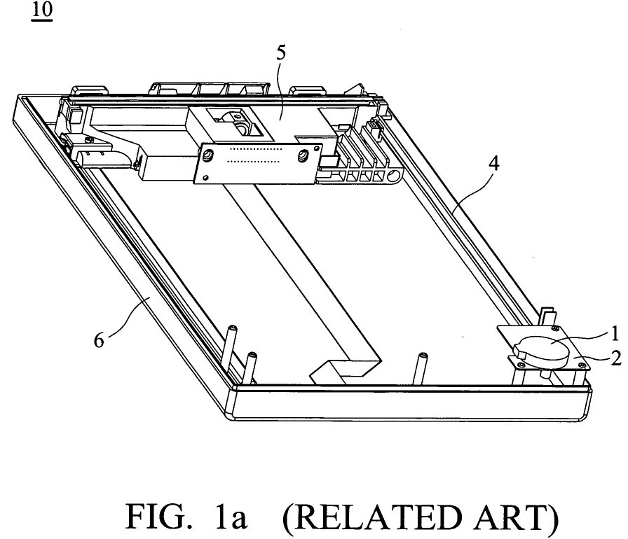

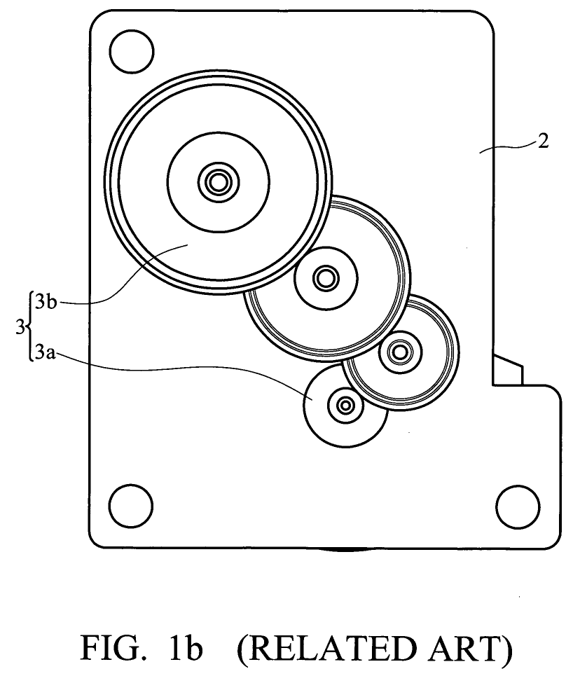

### DETAILED DESCRIPTION

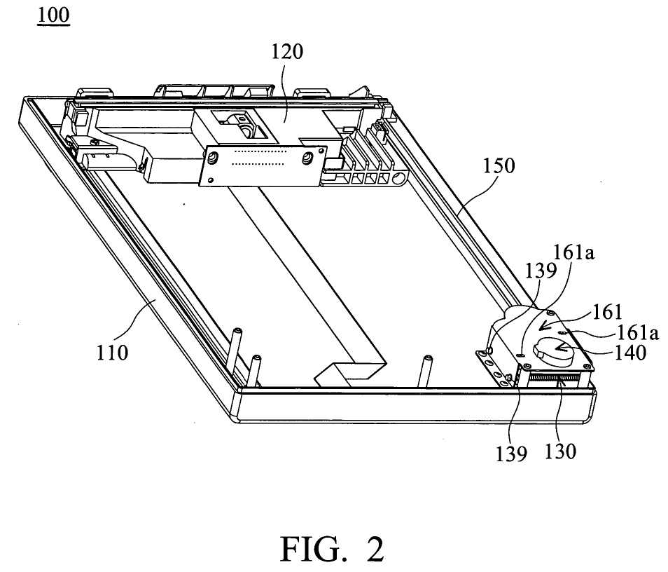

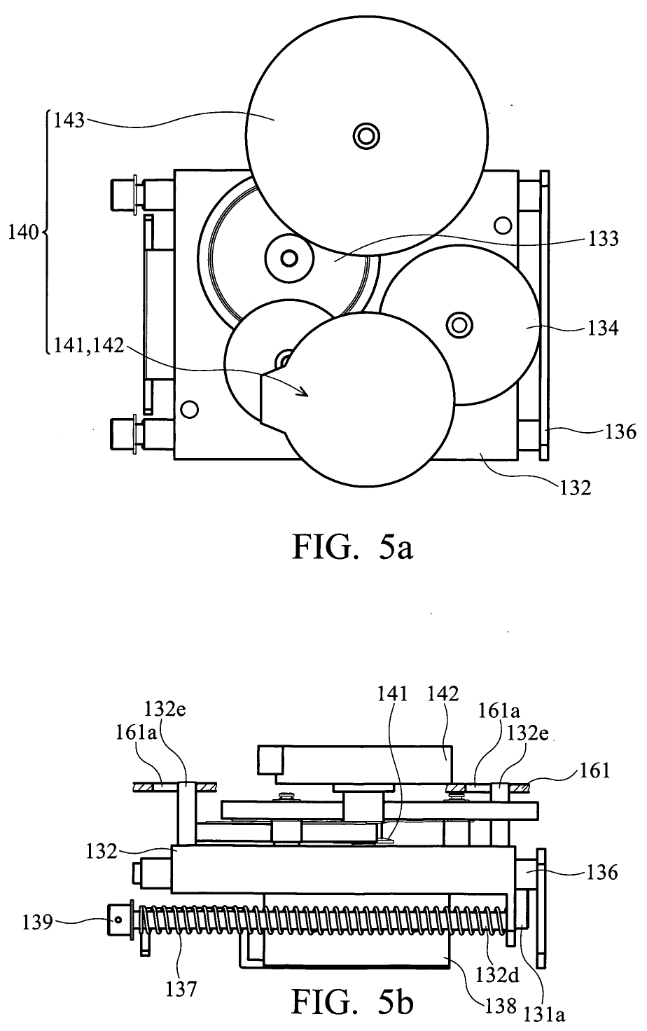

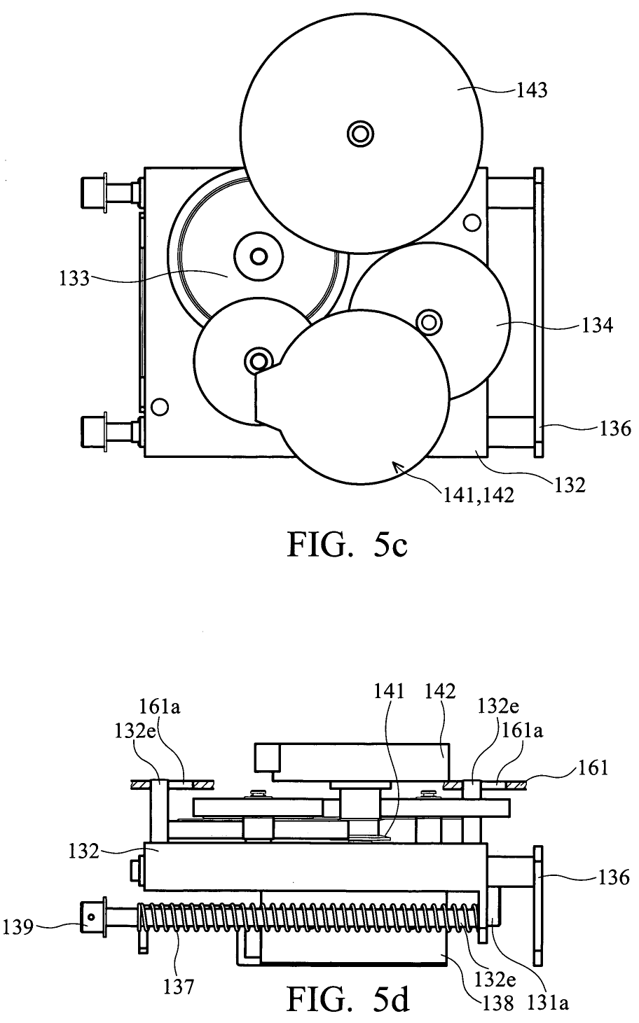

Referring to FIGS. 2 and 5b, an embodiment of an electronic device 100 comprises a housing 110, a passive module 120, a gear train module 130, a driving device 140, and a belt 150. The passive module 120 is movably disposed in the housing 110 via the belt 150.

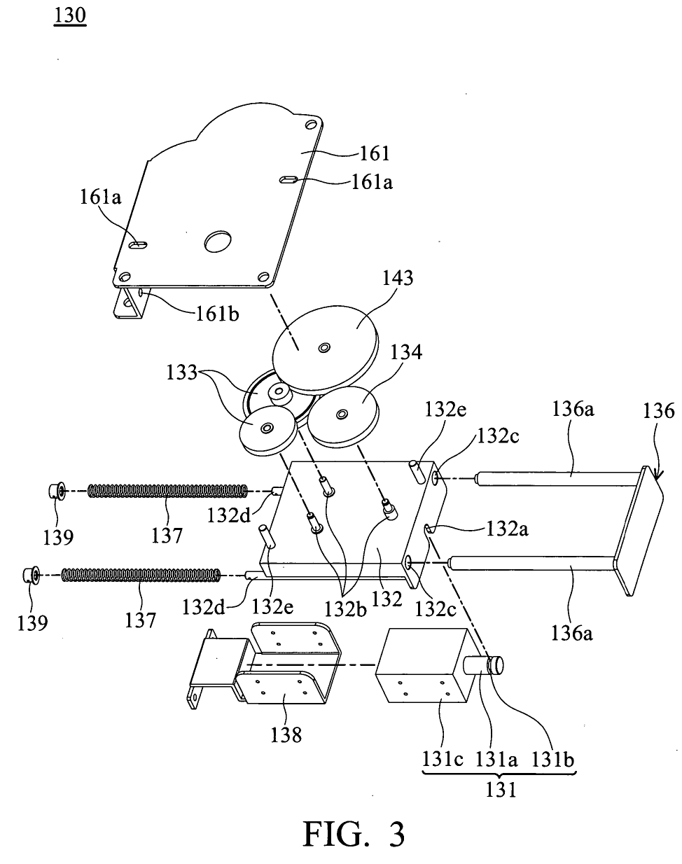

The gear train module 130 is disposed in the housing 110 to be connected to the passive module 120 via the belt 150. Referring to FIG. 3, the gear train module 130 comprises a solenoid valve 131, a sliding platform 132, a first gear unit 133, and a second gear unit 134, a sliding base 136, two elastic members 137, a supporting base 138, two combination members 139, and a base plate 161. The solenoid valve 131 is fixed to the housing 110 via the supporting base 138, and comprises a body 131c and a sliding rod 131a protruding from the body 131c. The sliding rod 131a is formed with a first engaging portion (groove) 131b thereon. When the solenoid valve 131 is not actuated, the sliding rod 131a is in a first position as shown in FIG. 5b. When the solenoid valve 131 is actuated, the sliding rod 131a is in a second position as shown in FIG. 5d.

Please refer to FIG. 3, the sliding platform 132 comprises a second engaging portion (notch) 132a, three axles 132b, two through holes 132c, two guiding rods 132d, and two pins 132e. The second engaging portion 132a is combined with the first engaging portion 131b of the sliding rod 131a; that is, the groove 131b of the sliding rod 131a is placed in the notch 132a of the sliding platform 132 to combine the sliding rod 131a and the sliding platform 132. Thus, the sliding platform 132 can be moved between the first position and the second position along with the first sliding rod 131a. The axles 132b are combined with the first gear unit 133 and the second gear unit 134 respectively so that both the first gear unit 133 and the second gear unit 134 are rotatably disposed on the sliding platform 132.

The first gear unit 133 is disposed on the sliding platform 132 via the axles 132b, and the first gear unit 133 comprises two gears as shown in FIG. 3. When the sliding platform 132 is in the first position as shown in FIG. 5b, the first gear unit 133 is engaged with an input gear 141 and an output gear 143 of the driving device 140, as shown in FIG. 5a. The second gear unit 134 is also disposed on the sliding platform 132 via the axle 132b, and comprises a single gear as shown in FIG. 3. When the sliding platform 132 is in the second position as shown in FIG. 5d, the second gear unit 134 is engaged with the input gear 141 and the output gear 143 of the driving device 140, as shown in FIG. 5c. Note that the speed reduction ratio of the first gear unit 133 is different from the speed reduction ratio of the second gear unit 134. In this embodiment, the speed reduction ratio of the first gear unit 133 is greater than the speed reduction ratio of the second gear unit 134.

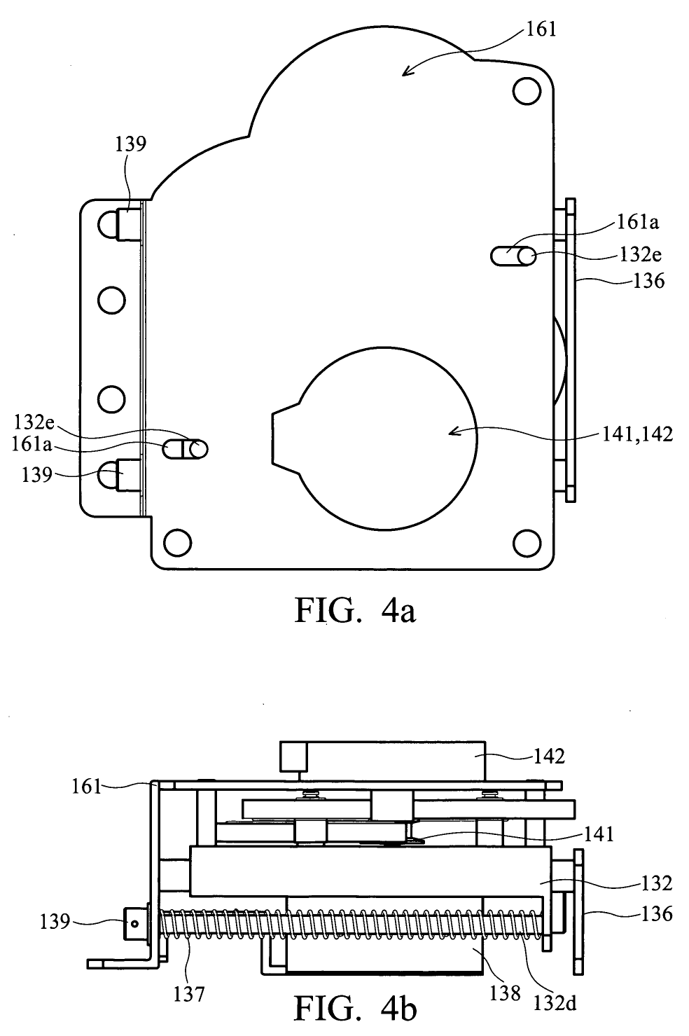

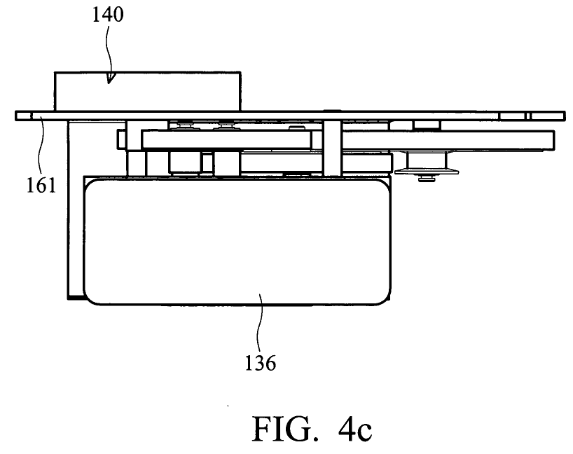

The sliding base 136 is fixed to the housing 110 at one end, and comprises two rods 136a at the other end, as shown in FIG. 3, to pass through the through holes 132c of the sliding platform 132 so that the sliding platform 132 is moved in a predetermined direction. Each rod 136a is fixed to the base plate 161 through the through hole 132c so that the sliding base 136 is fixed to the housing 110. Referring to FIG. 4b, each elastic member 137 is disposed on the guiding rod 132d of the sliding platform 132, wherein one end of the elastic member 137 abuts the sliding platform 132 to provide an elastic force to the sliding platform 132 so that the sliding platform 132 is maintained at the first position when the solenoid valve 131 is not actuated. The other end of the elastic member 137 abuts the base plate 161. Note that the elastic member 137 is a compression spring in this embodiment. The supporting base 138 is fixed to the housing 110 via the base plate 161. The body 131c of the solenoid valve 131 is combined with the supporting base 138 to be fixed to the housing 110. Specifically, the supporting base 138 comprises a plurality of through holes (not labeled), and the body 131c comprises a plurality of screw holes (not labeled) corresponding to the through holes of the supporting base 138. Screws are threaded with the screw holes of the body 131c via the through holes of the supporting base 138 so that the supporting base 138 is combined with the body 131c of the solenoid valve 131.

The base plate 161 comprises two openings 161a and two holes 161b, and is disposed in the housing 110. The pins 132e of the sliding platform 132 pass through the openings 161a so that the sliding platform 132 is at the second position when the solenoid valve 131 is actuated. Each combination member 139 is combined with the guiding rod 132d, passing through the hole 161b of the base plate 161.

Referring to FIG. 4c, the driving device 140 is disposed on the base plate 161. As shown in FIG. 5a, the driving device 140 comprises an input gear 141, a stepping motor 142, and an output gear 143. Both the input gear 141 and the output gear 143 may be moved along with the gear train module 130 so that the stepping motor 142 drives the passive module 120 via the input gear 141, the gear train module 130, and the belt 150. Furthermore, the output gear 143 is disposed in the housing 110 via the base plate 161, and drives the passive module 120 via the belt 150.

Note that the electronic device 100 may be a scanner or a printer, and the passive module 120 may be a scanning module or a printing module correspondingly.

The structure of the electronic device 100 is described as above, and the operation thereof is described in the following based on the scanner.

When scanning at high resolution, the solenoid valve 131 is not actuated (not magnetized) while the sliding platform 132 is located at the first position as shown in FIGS. 5a and 5b. At this moment, both the input gear 141 and the output gear 143 of the driving device 140 are engaged with the first gear unit 133, but not engaged with the second gear unit 134. The pin 132e of the sliding platform 132 is also located at the right side of the opening 161a of the base plate 161, and the elastic members 137 prevent the sliding platform 132 from moving toward the left during operation.

When scanning at low resolution or preview scanning, the solenoid valve 131 is actuated (magnetized) while the sliding platform 132 is located at the second position as shown in FIGS. 5c and 5d. At this time, both the input gear 141 and the output gear 143 of the driving device 140 are engaged with the second gear unit 134, but not engaged with the first gear unit 133. The pin 132e of the sliding platform 132 is moved toward the left side and is also positioned at the left side of the opening 161a of the base plate 161 so that the sliding platform 132 stops moving.

As previously described, the gear train module comprises two gear units with different speed reduction ratios in this embodiment, wherein the gear units can be switched by actuating the solenoid valve. Furthermore, the compression spring can absorb the push force during the operation of the gear train module, and the pins can control the movement of the gear train module. Additionally, since the sliding platform is moved along the parallel sliding base, the gear train module can be accurately switched.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a housing;
a passive module moveably disposed in the housing;
a gear train module disposed in the housing and connected to the passive module; and
a driving device comprising an input gear and an output gear, wherein both the input gear and the output gear are engaged with the gear train module to drive the passive module to move;
wherein the gear train module comprises:
a solenoid valve, fixed to the housing, comprising a body and a sliding rod protruded from the body, wherein the sliding rod is in a first position when the solenoid valve is not actuated, and the sliding rod is in a second position when the solenoid valve is actuated;
a sliding platform combined with the sliding rod, the sliding rod moving the sliding platform between the first position and the second position;
a first gear unit disposed on the sliding platform to be engaged with the input gear and the output gear when the sliding platform is in the first position; and
a second gear unit disposed on the sliding platform to be engaged with the input gear and the output gear when the sliding platform is in the second position.

2. The electronic device as claimed in claim 1, wherein the sliding rod comprises a first engaging portion, and the sliding platform comprises a second engaging portion combined with the first engaging portion to combine the sliding rod and the sliding platform.

3. The electronic device as claimed in claim 1, wherein the sliding platform comprises a plurality of axles combined with the first gear unit and the second gear unit respectively.

4. The electronic device as claimed in claim 1, wherein the sliding platform comprises at least one through hole, the gear train module further comprises a sliding base, one end of the sliding base is fixed to the housing, and the other end of the sliding base passes through the through hole so that the sliding platform is moved in a predetermined direction.

5. The electronic device as claimed in claim 1, wherein the gear train module further comprises an elastic member, one end of the elastic member abuts the sliding platform to provide an elastic force to the sliding platform so that the sliding platform is at the first position when the solenoid valve is not actuated.

6. The electronic device as claimed in claim 5, wherein the sliding platform further comprises a guiding rod on which the elastic member is disposed.

7. The electronic device as claimed in claim 1, wherein the gear train module further comprises a supporting base fixed to the housing, and the body of the solenoid valve is combined with the supporting base and fixed to the housing.

8. The electronic device as claimed in claim 7, wherein the gear train module further comprises a base plate combined with the supporting base, the base plate comprises an opening, the sliding platform comprises a pin passing through the opening so that the sliding platform is at the second position when the solenoid valve is actuated.

9. The electronic device as claimed in claim 8, wherein the driving device is disposed on the base plate.

10. The electronic device as claimed in claim 1, wherein the speed reduction ratio of the first gear unit is different from the speed reduction ratio of the second gear unit.

11. The electronic device as claimed in claim 1, wherein the electronic device is a scanner, and the passive module is a scanning module.

12. A gear train module, connecting a driving device comprising an input gear and an output gear, comprising:
a solenoid valve comprising a body and a sliding rod protruded from the body, wherein the sliding rod is in a first position when the solenoid valve is not actuated, and the sliding rod is in a second position when the solenoid valve is actuated;
a sliding platform combined with the sliding rod, the sliding rod moving the sliding platform between the first position and the second position;
a first gear unit disposed on the sliding platform to be engaged with the input gear and the output gear when the sliding platform is in the first position; and
a second gear unit disposed on the sliding platform to be engaged with the input gear and the output gear when the sliding platform is in the second position.

13. The gear train module as claimed in claim 12, wherein the sliding rod comprises a first engaging portion, and the sliding platform comprises a second engaging portion combined with the first engaging portion to combine the sliding rod and the sliding platform.

14. The gear train module as claimed in claim 12, wherein the sliding platform comprises a plurality of axles combined with the first gear unit and the second gear unit respectively.

15. The gear train module as claimed in claim 12, wherein the sliding platform comprises at least one through hole, the gear train module further comprises a, one end of the sliding base is fixed to the housing, and the other end of the sliding base passes through the through hole so that the sliding platform is moved in a predetermined direction.

16. The gear train module as claimed in claim 12, further comprising a base plate with an opening, wherein the sliding platform comprises a pin passing through the opening so that the sliding platform is at the second position when the solenoid valve is actuated.

17. The gear train module as claimed in claim 12, further comprising an elastic member, wherein one end of the elastic member abuts the sliding platform to provide elastic force to the sliding platform so that the sliding platform is at the first position when the solenoid valve is not actuated.

18. The gear train module as claimed in claim 17, wherein the sliding platform further comprises a guiding rod on which the elastic member is disposed.

19. The gear train module as claimed in claim 12, further comprising a supporting base combined with the body of the solenoid valve.

20. The gear train module as claimed in claim 12, wherein the speed reduction ratio of the first gear unit is different from the speed reduction ratio of the second gear unit.
